(19) United States
(12) Patent Application Publication
(10) Pub. No.: US 2016/0224991 A1
(43) Pub. Date: Aug. 4, 2016

(54) EVALUATING FEATURES FOR A WEBSITE WITHIN A SELECTED INDUSTRY VERTICAL

(71) Applicant: Go Daddy Operating Company, LLC, Scottsdale, AZ (US)

(72) Inventors: Rajatish Mukherjee, Sunnyvale, CA (US); Justin Tsai, San Francisco, CA (US); Sandeep Grover, Sunnyvale, CA (US)

(21) Appl. No.: 14/610,701

(22) Filed: Jan. 30, 2015

(51) Int. Cl. G06Q 30/02; G06F 17/30

(52) U.S. Cl. CPC G06Q 30/0201; G06F 17/30876; G06F 17/3089

(57) ABSTRACT

A system and method are presented for website evaluation within an industry vertical. A request for evaluation of an existing website is received by one or more servers communicatively coupled to a network from a user. The new website belongs to an industry identified by the user. The one or more servers identifies a plurality of existing websites belonging to the same industry identified by the user and determines whether the plurality of existing websites are successful based on a success metric. The one or more servers identifies common attributes among the plurality of existing websites based on website related data and evaluates the website requested from the user. A report is generated that includes data related to one or more of the common attributes of one or more of the plurality of existing websites determined to be successful. A user interface including the report is displayed to the user.

### FIELD OF THE INVENTION

The present invention generally provides for the generation of website content related to an industry vertical and, more specifically, the generation of website content optimized for a particular industry vertical.

### BACKGROUND

A network is a collection of links and nodes (e.g., multiple computers and/or other devices connected together) arranged so that information may be passed from one part of the network to another over multiple links and through various nodes. Examples of networks include the Internet, the public switched telephone network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as web pages. Websites comprise a collection of connected or otherwise related web pages. The combination of all the websites and their corresponding web pages on the Internet is generally known as the World Wide Web (WWW) or simply the Web.

For Internet users and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other.

Websites may be created using HyperText Markup Language (HTML) to generate a standard set of tags that define how the web pages for the website are to be displayed. Users of the Internet may access content providers' websites using software known as an Internet browser, such as MICROSOFT INTERNET EXPLORER, MOZILLA FIREFOX, or GOOGLE CHROME. After the browser has located the desired webpage, the browser requests and receives information for the webpage, typically in the form of an HTML document, and then displays the webpage content for the user. The user then may view other web pages at the same website or move to an entirely different website using the browser.

With the vast array of website building tools available on the market today, Internet users can easily develop a web presence for their business. However, a number of websites fail due to ineffective strategic planning, poor website design, and lack of promotion. In order to develop a successful website, website developers need to reach potential website visitors and convert those visitors into buyers. However, many website developers may not have the resources necessary to develop a website that is targeted to the proper demographic, thereby resulting in a website with little traffic and low profits.

Poor website design is another reason many websites fail to profit. Often times, websites are too complicated and include, for example, too much animation, too many menu items, an overwhelming number of links, a distracting color scheme, and the like. This can prevent potential customers from absorbing the content within website because they are simply too distracted. Thus, the layout and well chosen graphics can affect the success of a website.

To complicate the process of website design further, the content and layout best suited for a particular customer varies by industry. Many websites have interesting content, and plenty of eye-friendly design to help users from becoming overwhelmed, but often the content does not clearly identify what industry it is in and what the website is actually trying to portray.

Thus, there is a need for a system and method that allows website developers to create a profitable website that includes an effective strategic plan, a balanced website design, and content directed towards the targeted customers within a selected industry.

### SUMMARY OF THE INVENTION

The present invention overcomes the aforementioned drawbacks by providing a system and method for evaluating a website belonging to an industry requested by a user. The industry requested by the user can include, but is not limited to, music, dental, food, real estate, education, retail, automotive, energy, technology, transportation, manufacturing, banking, finance, government, healthcare, and the like. A software application is provided that identifies, using an industry identification module, existing websites within the same industry vertical identified by the user. A website content scanner scans the content within the existing websites to obtain website related data there from. The website related data can include, but is not limited to, meta tags, search engine optimization (SEO) data, keyword data, appearance data, and business related data. A website generation module can then identify common attributes and success data for the existing websites. The success data can include, for example, website traffic, sales data, website ratings, social media ratings, and the like. The common attributes of the existing websites determined to be successful can then be used by the website generation module to automatically evaluate attributes of the website and generate a report including a comparison of the attributes of the website and the effective attributes of successful websites within the same industry vertical. The user can then customize the website by providing specific business related data, such as a business name and business address, as well as customized appearance data, such as color, images, logos, and the like.

In accordance with one aspect of the invention, a method includes receiving, by one or more servers communicatively coupled to a network, a request from at least one of a web browser and a computing device of a user for evaluation of a website. The new website belongs to an industry identified by the user. The one or more servers accesses a remote data source to identify a plurality of existing websites belonging to the industry identified by the user. The remote data source stores industry identifiers for each of the plurality of existing websites. The one or more servers determines whether the plurality of existing websites are successful based on a success metric calculated using a weighted algorithm based on at least one of relevant metadata and a maximum potential market reach for the plurality of existing websites within the industry and a predetermined geographic location. The weighted algorithm requires input data related to sources of website traffic weighted against the industry vertical and the predetermined geographic location and website ratings. The one or more servers identifies common attributes among the plurality of existing websites determined to be successful. The one or more servers compares attributes of the website requested from the user to one or more of the common attributes of one or more of the plurality of existing websites determined to be successful once the success metric is normalized based on the maximum potential market reach. A report on a user interface including data related to the compared attributes is displayed to the user.

In accordance with another aspect of the invention, a method includes receiving, by one or more servers communicatively coupled to a network, a request from at least one of a web browser and a computing devices of a user for evaluation of a website. The website belongs to an industry identified by the user. The one or more servers identify common attributes among a plurality of existing websites within the industry identified by the user. The common attributes are derived from a weighted algorithm based on at least one of relevant metadata and a maximum potential market reach for the plurality of existing websites within the industry and a predetermined geographic location. The one or more servers compares attributes of the website requested from the user to one or more of the common attributes of one or more of the plurality of existing websites. A report on a user interface including data related to the compared attributes is displayed to the user.

In accordance with another aspect of the invention, a system includes one or more servers communicatively coupled to a network. The one or more servers include a processor configured to receive a request from at least one of a web browser and a computing device of a user for evaluation of a website. The website belongs to an industry identified by the user. The processor is further configured to access a remote data source to identify a plurality of existing websites belonging to the industry identified by the user. The remote data source stores industry identifiers for each of the plurality of existing websites.

The processor is further configured to determine whether the plurality of existing websites are successful based on a success metric calculated using a weighted algorithm. The weighted algorithm is based on at least one of relevant metadata and a maximum potential market reach for the plurality of existing websites within the industry and a predetermined geographic location. The weighted algorithm requires input data related to sources of website traffic weighted against the industry vertical and the predetermined geographic location and website ratings. The processor is further configured to identify common attributes among the plurality of existing websites based on website related data obtained by the one or more servers once the success metric is normalized based on the maximum potential market reach. The processor compare attributes of the website requested from the user to one or more of the common attributes of one or more of the plurality of existing websites determined to be successful. A report on a user interface including the data related to the compared attributes is displayed to the user.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is a block diagram of a system that may be used to generate a website within a requested industry vertical.

FIG. 2 is a flow chart illustrating an example method by which a website for the requestor can be generated within the industry vertical.

FIG. 3 is a screenshot showing an example user interface by which the requester can build a new website using a website builder application.

FIG. 4 is a screenshot showing an example existing website from which a portion of the new website for the requestor can be created.

FIG. 5 is a flow chart illustrating an example method by which common text characteristics can be identified among successful websites within the industry vertical.

FIG. 6 is an example report illustrating recommended percentages of text characteristics and a recommended level of formalness from which the new website can incorporate.

FIG. 7 is a flow chart illustrating an example method by which color data can be identified among successful websites within the industry vertical.

FIG. 8 is a flow chart illustrating an example method by which image characteristics can be identified among successful websites within the industry vertical.

FIG. 9 is a flow chart illustrating an example method by which a text-to-image ratio can be identified among web pages of successful websites within the industry vertical.

FIG. 10 is a flow chart illustrating an example method by which embedded widgets can be identified among successful websites within the industry vertical.

FIG. 11 is a screen shot shown an example newly generated website within the specified industry vertical.

FIG. 12 is a screenshot showing an example form the requester can complete to provide business data while using the website builder application.

### DETAILED DESCRIPTION

The present invention will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

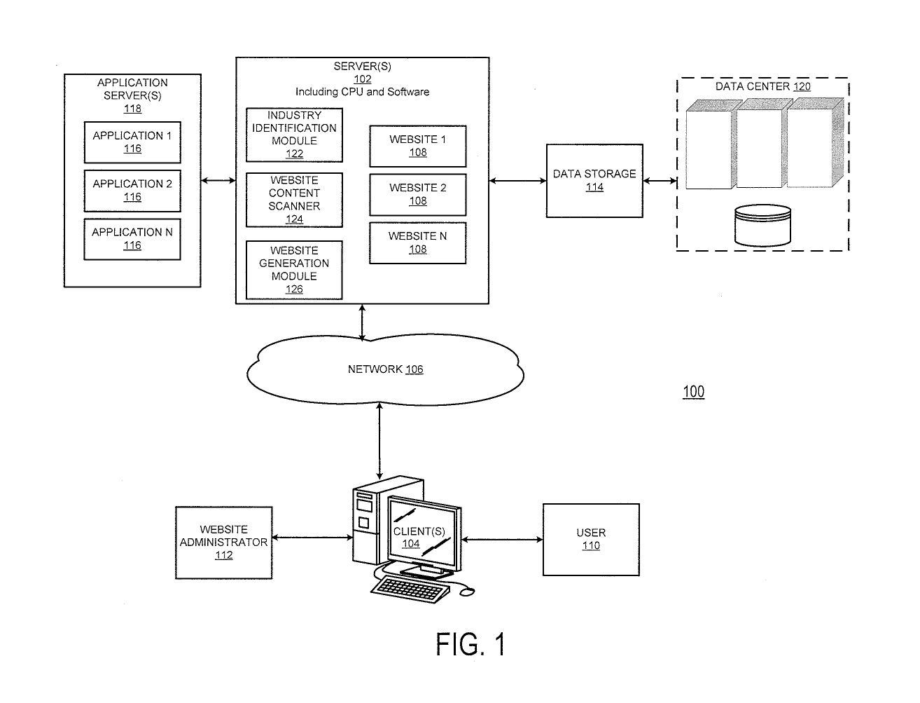

FIG. 1 is a block diagram of a system 100 that may be used to practice the present invention. The methods and embodiments disclosed and described herein may be performed by any central processing unit (CPU) in the system 100, such as a microprocessor running on at least one server 102 and/or client 104, and executing instructions stored (perhaps as scripts and/or software, possibly as software modules) in computer-readable media accessible to the CPU, such as a hard disk drive on the server 102 and/or client 104.

The example embodiments herein place no limitations on whom or what may comprise users. Thus, as non-limiting examples, users may comprise any individual, entity, business, corporation, partnership, organization, governmental entity, and/or educational institution.

The example embodiments shown and described herein exist within the framework of a network 106 and should not limit possible network configuration or connectivity. Such a network 106 may comprise, as non-limiting examples, any combination of the Internet, the public switched telephone network, the global Telex network, computer networks (e.g., an intranet, an extranet, a local-area network, or a wide-area network), a wired network, a wireless network, a telephone network, a corporate network backbone or any other combination of known or later developed networks.

The network 106 allows the easy and robust exchange of information between websites 108 on hardware servers 102 and Internet users 110 and website administrators 112 on client computers. Hundreds of millions of people around the world have access to client computers connected to the Internet via Internet Service Providers (ISPs).

At least one server 102 and at least one client 104 may be communicatively coupled to the network 106 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

The server(s) 102 and client(s) 104 (along with software modules and data storage 114 disclosed herein) may be communicatively coupled to the network 106 and to each other in such a way as to allow the exchange of information required to accomplish the method steps disclosed herein, including, but not limited to receiving the information from a user interface on one or more clients 104, and one or more servers 102 receiving the information.

The client 104 may be any computer or program that provides services to other computers, programs, or users either in the same computer or over the computer network 106. As non-limiting examples, the client 104 may be an application, communication, mail, database, proxy, fax, file, media, web, peer-to-peer, or standalone computer, cell phone, “smart” phone, personal digital assistant (PDA), etc. which may contain an operating system, a full file system, a plurality of other necessary utilities or applications or any combination thereof on the client 104. Non limiting example programming environments for client applications may include JavaScript/AJAX (client side automation), ASP, JSP, Ruby on Rails, Python's Django, PHP, HTML pages or rich media like Flash, Flex, Silverlight, any programming environments for mobile “apps,” or any combination thereof.

The client computer(s) 104 which may be operated by one or more users 110 and may be used to connect to the network 106 to accomplish the illustrated embodiments may include, but are not limited to, a desktop computer, a laptop computer, a hand held computer, a terminal, a television, a television set top box, a cellular phone, a wireless phone, a wireless hand held device, a “smart” phone, an Internet access device, a rich client, thin client, or any other client functional with a client/server computing architecture. Client software may be used for authenticated remote access to one more hosting computers or servers, described below. These may be, but are not limited to being accessed by a remote desktop program and/or a web browser, as are known in the art.

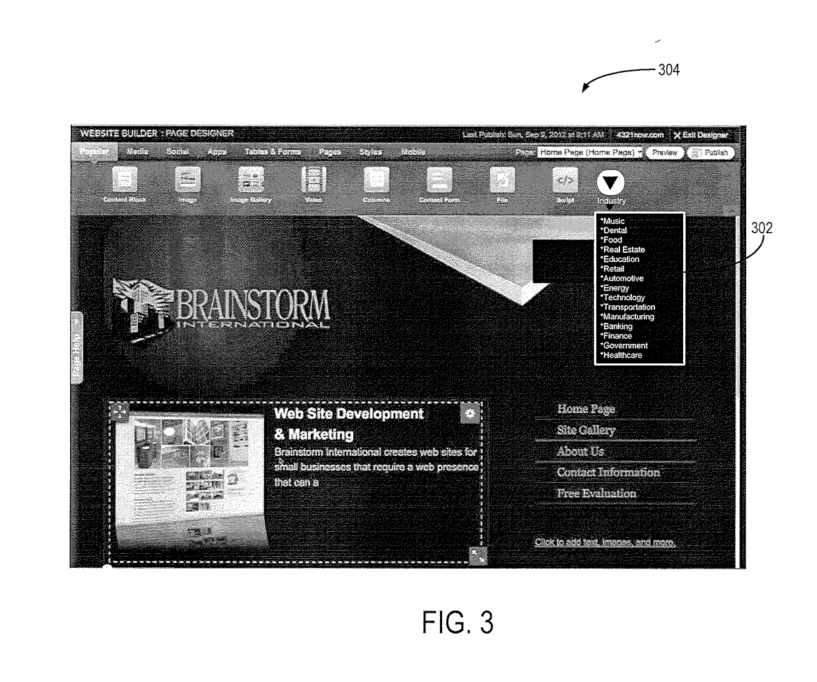

The user interface displayed on the client(s) 104 or the server(s) 102 may be any graphical, textual, scanned and/or auditory information a computer program presents to the user, and the control sequences such as keystrokes, movements of the computer mouse, selections with a touch screen, scanned information etc. used to control the program. Examples of such interfaces include any known or later developed combination of Graphical User Interfaces (GUI) or Web-based user interfaces as seen in and after FIG. 3, including Touch interfaces, Conversational Interface Agents, Live User Interfaces (LUI), Command line interfaces, Non-command user interfaces, Object-oriented User Interfaces (OOUI) or Voice user interfaces. Any information generated by the user, or any other information, may be accepted using any field, widget and/or control used in such interfaces, including but not limited to a text-box, text field, button, hyper-link, list, drop-down list, check-box, radio button, data grid, icon, graphical image, embedded link, etc.

The software modules used in the context of the current invention may be stored in the memory of and run on at least one server 102 and/or client 104. The software modules may comprise software and/or scripts containing instructions that, when executed by a microprocessor on the server 102 and/or client 104, cause the microprocessor to accomplish the purpose of the module or the methods disclosed herein.

The software modules may interact and/or exchange information via an Application Programming Interface or API. An API may be a software-to-software interface that specifies the protocol defining how independent computer programs interact or communicate with each other. The API may allow a requesting party's software to communicate and interact with the software application and/or its provider-perhaps over a network-through a series of function calls (requests for services). It may comprise an interface provided by the software application and/or its provider to support function calls made of the software application by other computer programs, perhaps those utilized by the requesting party to provide information for publishing or posting domain name and hosted website information.

The API may comprise any API type known in the art or developed in the future including, but not limited to, request-style, Berkeley Sockets, Transport Layer Interface (TLI), Representational State Transfer (REST), SOAP, Remote Procedure Calls (RPC), Standard Query Language (SQL), file transfer, message delivery, and/or any combination thereof.

The software modules may also include mobile applications, possibly on a client computer and/or mobile device. These mobile applications or “apps” may comprise computer software designed to help people perform an activity and designed to help the user to perform singular or multiple related specific tasks.

The server(s) 102 utilized within the disclosed system 100 may comprise any computer or program that provides services to other computers, programs, or users either in the same computer or over the computer network 106. As non-limiting examples, the server 102 may comprise application, communication, mail, database, proxy, fax, file, media, web, peer-to-peer, standalone, software, or hardware servers (i.e., server computers) and may use any server format known in the art or developed in the future (possibly a shared hosting server, a virtual dedicated hosting server, a dedicated hosting server, a cloud hosting solution, a grid hosting solution, or any combination thereof).

The server 102 may exist within a server cluster. These clusters may include a group of tightly coupled computers that work together so that in many respects they can be viewed as though they are a single computer. The components may be connected to each other through fast local area networks which may improve performance and/or availability over that provided by a single computer.

Some website administrators 112, typically those that are larger and more sophisticated, may provide their own hardware server(s) 102, software, and connections to the Internet. But many website administrators 112 either do not have the resources available or do not want to create and maintain the infrastructure necessary to host their own websites 108. To assist such individuals (or entities), hosting providers exist that offer website 108 hosting services on the server(s) 102. The hosting providers or other third parties may also provide one or more software applications 116 to assist a website administrator 112 in constructing their website 108. The software applications 116 may include website builders for conventional and/or mobile-oriented websites 108, checkout or purchase processing software, marketing tools, and other software widgets that can be incorporated into the website 108.

The software applications 116 may be provided by one or more application servers 118 that are in communication with the server 102. The application servers 118 may be implemented as separate computer servers from server 102, and so may be distributed over a geographical region. Or, in other cases, the application servers 118 may be implemented on or by server 102.

The server 102, client 104, and/or the application server 118 may be communicatively coupled to the data storage 114 to retrieve any information requested. The data storage 114 may be any computer components, devices, and/or recording media that may retain digital data used for computing for some interval of time. The storage may be capable of retaining stored content for any data requested, on a single machine or in a cluster of computers over the network 106, in separate memory areas of the same machine such as different hard drives, or in separate partitions within the same hard drive, such as a database partition.

The server(s) 102 or software modules within the server(s) 102 may use query languages such as MSSQL or MySQL to retrieve the content from data storage 114. Server-side scripting languages such as ASP, PHP, CGI/Perl, proprietary scripting software/modules/components etc. may be used to process the retrieved data. The retrieved data may be analyzed in order to determine information recognized by the scripting language, information to be matched to those found in data storage, availability of requested information, comparisons to information displayed and input/selected from the user interface or any other content retrieval within the method steps disclosed herein.

Non-limiting examples of the data storage 114 may include, but are not limited to, a Network Area Storage, (“NAS”), which may be a self-contained file level computer data storage connected to and supplying a computer network with file-based data storage services. The storage subsystem may also be a Storage Area Network (“SAN”—an architecture to attach remote computer storage devices to servers in such a way that the devices appear as locally attached), an NAS-SAN hybrid, any other means of central/shared storage now known or later developed or any combination thereof.

Structurally, the data storage 114 may comprise any collection of data. As non-limiting examples, the data storage 114 may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, and/or other means of data storage such as a magnetic media, hard drive, other disk drive, volatile memory (e.g., RAM), non-volatile memory (e.g., ROM or flash), and/or any combination thereof.

The server(s) 102 and the data storage 114 may exist and/or be hosted in one or more data centers 120. These data centers 120 may provide hosting services for websites, services or software relating to stored information, or any related hosted website including, but not limited to hosting one or more computers or servers in a data center 120 as well as providing the general infrastructure necessary to offer hosting services to Internet users including hardware, software, Internet websites, hosting servers, and electronic communication means necessary to connect multiple computers and/or servers to the Internet or any other network 106. These data centers 120 or the related clients 104 may accept messages from text messages, SMS, web, mobile web, instant message, third party API projects or other third party applications.

As users access and/or input information, this information may be redirected and distributed between and among the data centers 120 via commands from any combination of software applications 116 hosted on the application server(s) 118 and executed via processors on the server(s) 102. This information may then be accessed and manipulated by the combination of software modules or stored in the data storage 114 of any of a plurality of data centers, either separate from or integrated into the one or more servers, so that the information is available to be searched and accessed by the user and/or any other components of any or all data centers.

Any references to “software combination,” “combination of software,” “combination of software modules” etc. referred to herein may include any combination of software modules executed by a microprocessor on either the server 102 or client 104 computers. These software modules may also be used in combination with any other hardware or software structures disclosed herein. The servers 102 may be hosted in any data center 120 operated by any hosting provider such as those disclosed herein and the servers 102 and clients 104 may be operated by any users disclosed herein.

Using the present system 100, the website administrator 112 may access the server 102 for the purpose of hosting, creating, or modifying a website 108. To do so, the website administrator 112 may log into an authentication website provided by server 102. Once authenticated, the website administrator 112 can execute one or more applications 116 that are configured to assist in the process of creating, editing, and managing the website 108, for example.

The system 100 also may comprise an industry identification module 122 that may be stored in the memory of—and run on—at least one server 102 and may comprise any software and/or scripts containing instructions that, when executed by the server's 102 microprocessor, cause the microprocessor to identify existing websites hosted on the server 102, for example, that belong to an industry vertical selected by the website administrator 112. The industry identification module 122 may have stored thereon, predetermined website patterns corresponding to different industries (e.g., music, dental, food, real estate, education, retail, automotive, energy, technology, transportation, manufacturing, banking, finance, government, healthcare, etc.). As a non-limiting example, if the website administrator 112 requests to build a website in the music industry, the industry identification module 122 can identify other existing websites in the music industry based on the content and attributes of the website determined to match the predetermined website patterns for websites in the music industry, as will be described in further detail below.

The system 100 may also include a website content scanner 124 that may be stored in the memory of—and run on—at least one server 102 and may comprise any software and/or scripts containing instructions that, when executed by the server's 102 microprocessor, cause the microprocessor to scan the content of the existing websites identified by the industry identification module 122 and obtain corresponding website related data including, but not limited to, meta tag data, search engine optimization data, keyword data, appearance data, and business related data. Once the website related data for each of the existing websites is obtained, a website generation module 126 can identify attributes common to the existing websites.

The website generation module 126 may be stored in the memory of—and run on—at least one server 102 and may comprise any software and/or scripts containing instructions that, when executed by the server's 102 microprocessor, cause the microprocessor to generate the new website within the previously identified industry vertical. The new website may include the attributes common to the existing websites determined to be successful by the website generation module 126 in the same industry vertical. In an alternative embodiment, the microprocessor may be configured to update a pre-existing website to include the attributes common to the successful websites in the same industry vertical. The server 102, on which the website generation module 126 can reside, may then be configured to provide the website administrator 112 a user interface to customize the new website, as will be described below.

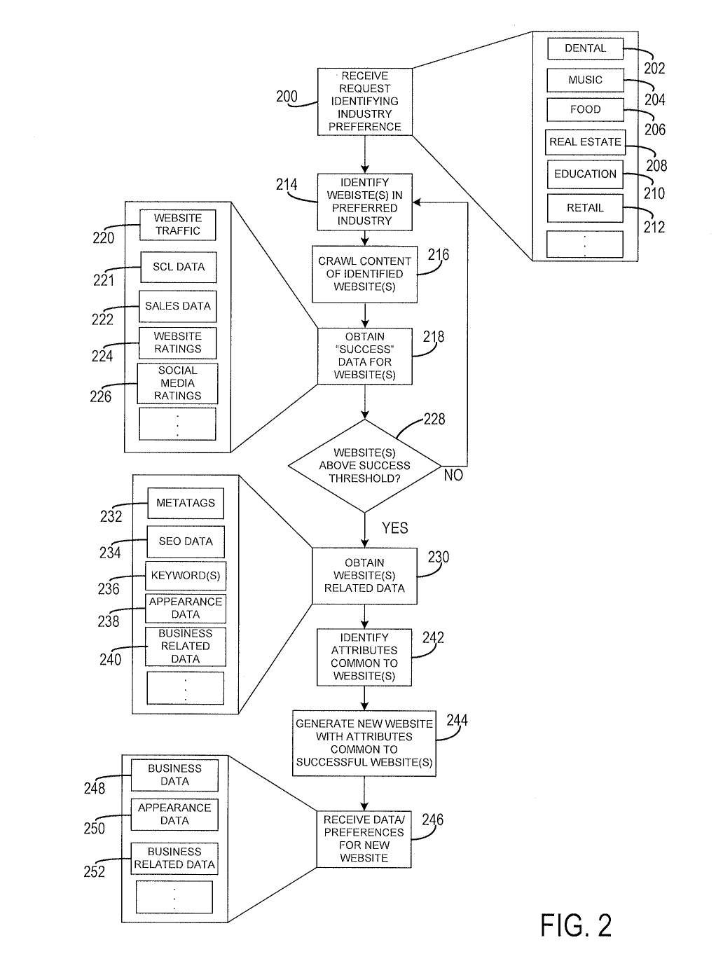

Turning now to FIG. 2, a flow chart illustrating an example method by which a new website 108 is automatically generated, or an existing website updated, based on an industry vertical selected by the website administrator 112 or user 110 of FIG. 1 is shown. The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Returning to FIG. 2, to begin the process, the server 102 can receive a request for generating a new website 108, where the request identifies an industry vertical for the new website 108 in step 200. As used herein, the term “industry vertical” should be construed as a category or type used to describe any type of business or the business' website, as well as any other entity or entities that may interact with the present system (e.g., educational entities, non-profit companies, personal groups, individuals, and the like). The websites can include informative and/or non-static websites (i.e., the website content is continually updated). Types of informative and/or non-static websites may include, for example, personal websites, blogs, political discussions, and the like. The request may be received, for example, from the website administrator 112. One of several industry verticals may be identified in the request including, but not limited to, dental, as shown at block 202, music, as shown at block 204, food, as shown at block 206, real estate, as shown at block 208, education, as shown at block 210, and retail, as shown at block 212. Other industry verticals can include, but are not shown in FIG. 2, automotive, energy, technology, transportation, manufacturing, banking, finance, government, healthcare, and the like.

In one non-limiting example, as shown in FIG. 3, the industry vertical specified by the website administrator 112 can be selected using a pull-down menu, such as the pull-down menu 302 shown on user interface 304 in FIG. 3. The user interface 304 may be provided to the website administrator 112 by one or more applications 116 hosted by the application server 118 of FIG. 1. The website administrator 112 accesses the website builder application to create a new website 108, or update an existing website. Upon accessing the website builder application, the industry pull-down menu 302 can be used to select a preferred industry vertical in which the new website 108 is to be generated. In one example, the application 116 may include a website builder, such as GODADDY.COM's Website Builder (WSB) Application. The website builder is a tool designed to assist a user in creating and modifying content for a website.

The website builder application may be provided, for example, via a website browser running on a conventional desktop computer system or a laptop. Alternatively, the website builder application may be executed via a mobile device, such as a smart phone. In that case, the interface of the website builder application may be configured to be suitable for display on a smaller screen and for user interactions involving tapping and dragging upon a touch screen. The website builder may be executed as a software program running on a computing device of the website administrator 112 (e.g., as native software), or may run within a web browser (e.g., as a hosted software application), or combinations thereof.

Returning to FIG. 2, once the server 102 receives the industry vertical preference at process block 200, the industry identification module 122 hosted on the server 102 can identify a plurality of existing websites 108 within the same industry vertical selected by the website administrator 112 at process block 214. In one non-limiting example, the industry identification module 122 may be configured to also identify a location (e.g., by analyzing contact information contained within one or more documents contained within the existing websites) for the existing websites. As such, if desired, the websites identified in the preferred industry at process block 214 may be limited to a particular geographic location. In one embodiment, for example, only existing websites that are associated with the same geographical region as the requester. This may be particularly useful, for example, when the existing websites 108 are hosted in different regions and/or countries, since website designs and formats can vary widely among different regions. The location of the request can be determined by any suitable means such as the requester communicating a location directly to the server 102, or by performing a reverse lookup on an IP address of the requester, for example.

In yet another non-limiting example, the industry identification module 122 can access the plurality of existing websites 108 that were built by other website administrators utilizing the website builder application 116 and hosted by the server 102. Thus, the plurality of existing websites 108 may have been created using templates (not shown) corresponding to specific industry verticals provided by the website builder application 116. The templates may include a number of pre-built web pages that each may include media (e.g., images, video, sounds, and the like) and/or text arranged within the template's web pages. The media and text incorporated into a particular template may be suited to the industry vertical selected by the website administrator 112. Therefore, the industry identification module 122 may easily identify the plurality of existing websites 108 within the industry vertical selected by the website administrator 112 by identifying the templates used to create the websites 108.

However, if one or more of the plurality of existing websites 108 are created with a different website builder application hosted on a server other than the server 102 of FIG. 1, the industry identification module 122 may be configured to identify the plurality of existing websites corresponding to the preferred industry vertical in a different manner. Similarly, if one or more of the plurality of existing websites 108 are created with the same website builder application 116, as previously described, but the website administrator 112 chose not to use an industry specific, pre-built template, the industry identification module 122 may be configured to identify the plurality of existing websites 108 corresponding to the preferred industry vertical by scanning and/or crawling the content of the existing websites at process block 216.

Scanning the content of the plurality of existing websites 108 within the preferred industry vertical at process block 216 can be accomplished by utilizing the website content scanner 124 of FIG. 1. As the website content scanner 124 scans the content of the existing websites 108, success data for each of the plurality of existing websites 108 may be obtained at process block 218. The success data may include, but is not limited to, website traffic, as shown at block 220, spam confidence level (SCL) data, as shown at block 221, sales data, as shown at block 222, website ratings, as shown at block 224, and social media ratings, as shown at block 226.

Website traffic 220 can be obtained for the existing websites hosted on the server 102 of FIG. 1, for example, and is accessible by the website content scanner 124. The website traffic data 220 may be a numeric value of the quantity of internet users visiting the existing website. The quantity of internet users visiting the existing website may be obtained through traffic statistics identified in a log file (not shown) stored on the server 102, for example. Additionally, or alternatively, the website traffic data 220 may be obtained by a tracking application external to the website that is configured to record traffic by inserting a small piece of HTML code in the website pages. Alternatively, the quantity of site visits to the existing websites may be obtained using Domain Name System (DNS) routing that logs the number of DNS requests for a particular website. As such, a higher number of DNS requests can be indicative of a higher volume of website traffic to the website. A higher value of website traffic may be related to the success of the existing website.

In addition, the SCL data 221 may be acquired for the existing websites hosted on the server 102 by the website content scanner 124. For example, when an email message goes through spam filtering, the email message is assigned a spam score. That score is mapped to an individual SCL rating and stamped in an X-header within the HTML code. Typically the SCL rating ranges from −1 (i.e., non-spam) to 9 (i.e., high confidence spam). Thus, if the SCL rating indicates that the email address associated with the existing website is known for sending spam (i.e., a higher SCL rating), the website content scanner 124 may identify the existing website as unsuccessful, and the website generation module 126 may not recommend features of the unsuccessful website to the website administrator 112.

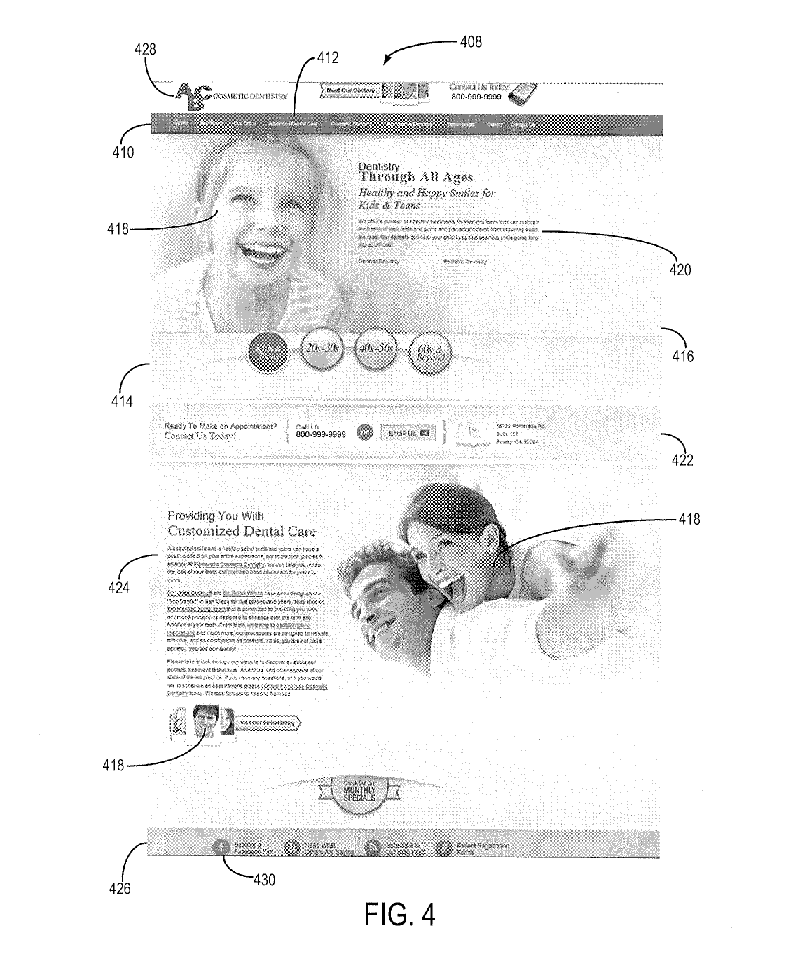

Similarly, the sales data 222 may be acquired for the existing websites hosted on the server 102 by the website content scanner 124. The sales data 222 may be a numeric value of the quantity of product sold and/or the dollar amount corresponding to the quantity of product sold. In the case where a website does not sell a physical product, such as a cosmetic dentistry website 408 shown in FIG. 4, the sales data 222 may simply be a quantity of appointments scheduled through the website's 408 online booking capabilities, for example. In one example, a higher value of sales data may be related to the success of the existing website.

Website ratings 224 and social media ratings 226 may be another metric used in obtaining success data for the existing websites at process block 218 of FIG. 2. In some instances, the website ratings 224 and social media ratings 226 may include, for example, a quantity of FACEBOOK likes, a quantity of new social network followers, a quantity of customers that shared the website on social networks, a quantity and content of customer comments, new customer sign-ups, and the like.

More specifically, the quantity of FACEBOOK likes may be a numeric quantity of the customers and non-customers of the existing website who liked the website on FACEBOOK. For example, the existing website 408 shown in FIG. 4, includes an icon 430 that links customers to a corresponding FACEBOOK page. Similarly, the quantity of new social network followers may be a numeric quantity of customers and non-customers of the website who started following the business. The quantity of new social network followers may include, but is not limited to, new followers on FACEBOOK, Twitter, and the like. The quantity of customers that shared the website on social networks may include, but is not limited to, the quantity of customers that tweeted and/or re-tweeted the website on Twitter, the quantity of customers that shared the website on FACEBOOK or Twitter, for example, or posted the website on FACEBOOK. Thus, the quantity of customers that shared the website on social networks can be tracked and stored in the shared database and utilized by the website content scanner 124 to obtain success data at process block 218 of FIG. 2.

The quantity and content of customer comments may also be success data that is obtained at process block 218. The quantity of customer comments may be a numeric quantity of the customers and non-customers of the website who commented on one or more of the social networks that the website was on. As a non-limiting example, if the customer comments are generally negative regarding the website, the website generation module 126 may identify that particular website as being unsuccessful.

Once the success data is obtained at process block 218, the website generation module 126 may be configured to determine whether each of the plurality of existing websites within the preferred industry vertical are above a success threshold at process block 228. The success threshold may be a numerical value that includes at least a portion of the success data (i.e., website traffic, sales data, website ratings, social media ratings, etc.).

In one non-limiting example, the success score for the plurality of existing websites may be normalized based on the location and industry vertical to which the website belongs. For example, a success score of a website for a shoe store in Wichita would be normalized against the location (i.e., Wichita) and industry (i.e., retail). First, metadata relevant to the website may be obtained by the website content scanner 124 that is configured to scan meta tags 232 included in the Hypertext Markup Language (HTML), for example, that describe some aspect of the contents of the website. The meta tags 232 may then be analyzed using a weighing algorithm. In one example, a higher weight may be allocated to page-level meta tags in the <head> section of web pages of the website and for any industry-focused keywords in <h1>, <h2>, and <h3> sections of the website's HTML in order to determine the highest probability of words in the specific industry vertical.

Next, the weighted words for the website may be compared to the website's corresponding industry code to select the highest likelihood set of industries. In one non-limiting example, the industry code may be the code generated by the North American Industry Classification System (NAICS). The NAICS industry code is a 2-through 6-digit hierarchical classification system, offering five levels of detail. Each digit in the code is part of a series of progressively narrower categories, and the more digits in the code signify greater classification detail. The first two digits designate the economic sector, the third digit designates the subsector, the fourth digit designates the industry group, the fifth digit designates the NAICS industry, and the sixth digit designates the national industry. Thus, for the shoe store in Wichita, the NAICS industry code is 448210.

Once the highest likelihood set of industries is determined using the website's industry code, the website content scanner 124 may be configured to scan the website content for address information (e.g., zip codes, telephone area codes, etc), as well as perform searches on social media using the business name, email address, and phone number to find associated social media accounts, as will be described in further detail below.

Next, the maximum potential market reach of the website may be measured. Maximum potential market reach may be identified, for example, by a mile radius distance for which a particular industry typically serves. Given the example shoe store website in Wichita, the maximum potential may be about a 20 mile radius which may be determined by a database that matches up NAICS codes with whether the businesses are typically local, online, or hybrid. For local or hybrid businesses, for example, the radius distance for how far that industry typically serves is known. Additionally, or alternatively, the specific radius distance may be compared against census numbers to estimate the total population of the radius.

Once the relevant metadata and maximum potential market reach for the website within a particular industry vertical is identified, the success score may be calculated using the weighted algorithm shown in the equation below:

Success score=normalizer*site traffic=modifier*(a*_var1+b*_var2+ . . . z*_var1000)

Where the modifier depends on the industry vertical and geographic location, as determined by the metadata obtained from the website content scanner 124, for example. Coefficients a, b . . . z depend on specific sources of site traffic weighted against the industry vertical and geographic location. Coefficients of the weighted success algorithm may change continuously based on the level of effectiveness of a given source for the particular industry vertical and location. For example, Pinterest ratings for wedding dress makers overall is high. However, the weighting is much higher in certain geographic locations, such as Los Angeles, where there is highly dense Pinterest activity in that category. In contrast, other geographic locations, such as Wichita, the Pinterest activity is less dense in the category of wedding dresses. Thus, the coefficients of the weighted success algorithm may change continuously based on the level of effectiveness of a given source for the particular industry vertical and location.

The success variables (i.e., var1, var2 . . . var1000) provided in the success score algorithm above may include, but are not limited to, website ratings 224, social media ratings 226, website traffic, sources of website traffic (e.g., traffic from social media, prominent posters, and the like), geography of site visitors, and store ratings on places such as, Yelp.com and Opentable.com. To correct and alter the coefficients the algorithm looks at how all the non-site traffic variables affect the site traffic. Then, based on the maximum potential, as previously described, the success score is normalized.

In another example, the website content scanner 124 may obtain success data from the website 408 shown in FIG. 4. If the website 408 has a large quantity of website visitors (e.g., above 1,000 visitors per month), a large quantity of scheduled appointments, and large quantities of positive customer comments and FACEBOOK likes, for example, the website generation module 126 can assign the website 408 a success value above the success threshold. The large quantity of positive customer comments and FACEBOOK likes may be a function of the geographic location, the industry vertical, and the type of business, for example. Thus, as previously described, the coefficients may change continuously, and the success algorithm can learn over time what determines a successful number of FACEBOOK comments, for example. Once the website content scanner 124 has obtained the success data from each of the plurality of existing websites and identified the websites having a success metric above the success threshold, the website content scanner 124 can obtain website related data of the successful websites at process block 230.

However, if one of the plurality of existing websites has a small a quantity of website visitors (e.g., below 100 visitors per month), a small quantity of scheduled appointments, and large quantities of negative customer comments and very few FACEBOOK likes, for example, the website generation module can assign the website 408 a success value below the success threshold.

As the website content scanner 124 scans the content of the existing websites 108 that have been determined to be successful, website related data may be obtained at process block 230. Website related data can include, but is not limited to, meta tag data, as shown at block 232, search engine optimization (SEO) data, as shown at block 234, keyword data, as shown at block 236, appearance data, as shown at block 238, and business related data, as shown at block 240.

The exemplary existing website 408 is shown in FIG. 4 from which website related data may be obtained utilizing the website content scanner 124. For example, if the website administrator 112 selected “dental” as the preferred industry vertical for their new website, the industry identification module 122 may have identified the existing website 408 as belonging to the dental industry based on, for example, the pre-built template used during creation of the website 408. In addition, or alternatively, the website content scanner 124 may scan the content defining the website 408 in order to obtain the website related data and identify the industry vertical associated with the website 408 by processing that website related data.

In one example, the website content scanner 124 may be configured to scan meta tags 232 included in the Hypertext Markup Language (HTML), for example, that describe some aspect of the contents of the website 408. The information provided in the website's 408 meta tags can be used by the website content scanner 124 to index a page so that the industry identification module 122 can easily identify the industry vertical associated with the website 408. Conventionally, the meta tag 232 is placed near the top of the HTML in the web page as part of the heading. The website content scanner 124 may be configured to search for the keywords meta tags and the description meta tag, for example.

The keywords meta tag lists the words or phrases that best describe the contents of the page. For example, the keywords meta tag for the website 408 may include, but is not limited to, “teeth,” “dentist,” and “smile.” The description meta tag can include a brief one- or two-sentence description of the page. For example, the description meta tag for the website 408 may include “ABC Cosmetic Dentistry is a family-oriented practice that uses the latest technology and techniques to maximize patient convenience, comfort and satisfaction.” Thus, the website content scanner 124 can scan and store the meta tag data 232 of the website 408 for later use by the website generation module 126. For example, since the website 408 is classified as being successful, the website generation module 126 can use similar meta tag data 232 obtained from the website 408 in the new website to be generated.

In addition to obtaining meta tag data 232 at process block 230, as shown in FIG. 2, the website content scanner 124 may further be configured to obtain SEO data 234 from the plurality of existing websites determined to be successful. In one non-limiting example, SEO data may include keywords searched by consumers in a particular industry vertical, or a list of business-specific keywords based upon some, or all, of the websites' content. For example, in the case where the website 408 belongs to the dental industry, the website content scanner 124 may determine that the various procedures offered by ABC Cosmetic Dentistry may be candidate keywords for the keyword list. With reference to the website 408 in FIG. 4, for example, the website content scanner 124 may determine that keywords related to procedures, such as “fillings,” “repairs,” “root canal,” “crown,” “bridges,” and “implants” are adequate keywords to include in the SEO data 234. These procedures may be good candidates for the keyword list of the new dental website to be generated because they can target consumers that are searching for the procedures provided by the business. Further, the website content scanner 124 can scan and store the SEO data 234 of the website 408 for later use by the website generation module 126. For example, since the website 408 is classified as being successful, the website generation module 126 can use similar SEO data 234 obtained from the website 408 in the new website to be generated.

Similarly, keyword data, as shown at block 236, may be obtained from the successful, existing websites by the website content scanner 124 at process block 230. The keyword data 236 may include the keywords corresponding to the meta tag data 232 or the SEO data 234 previously described. Additionally, or alternatively, the keyword data 236 may be obtained by simply scanning the visible content, such as various text sections 420, 422, and 424 of the website 408 of FIG. 4 and described in further detail below. For example, the website content scanner 124 may scan the page of the website 408 of FIG. 4 to obtain keyword data 236 common to the dental industry, for example. Thus, once the website content scanner 124 scans various existing websites associated with the dental industry, for example, the various keyword data 236 can be compared, and keywords can be identified that are common among the various successful, existing websites. Then, the website content scanner 124 can store the keyword data 236 of the various existing websites for later use by the website generation module 126. For example, since the website 408 is classified as being successful, the website generation module 126 can use similar keyword data 236 obtained from the website 408 in the new dental website to be generated.

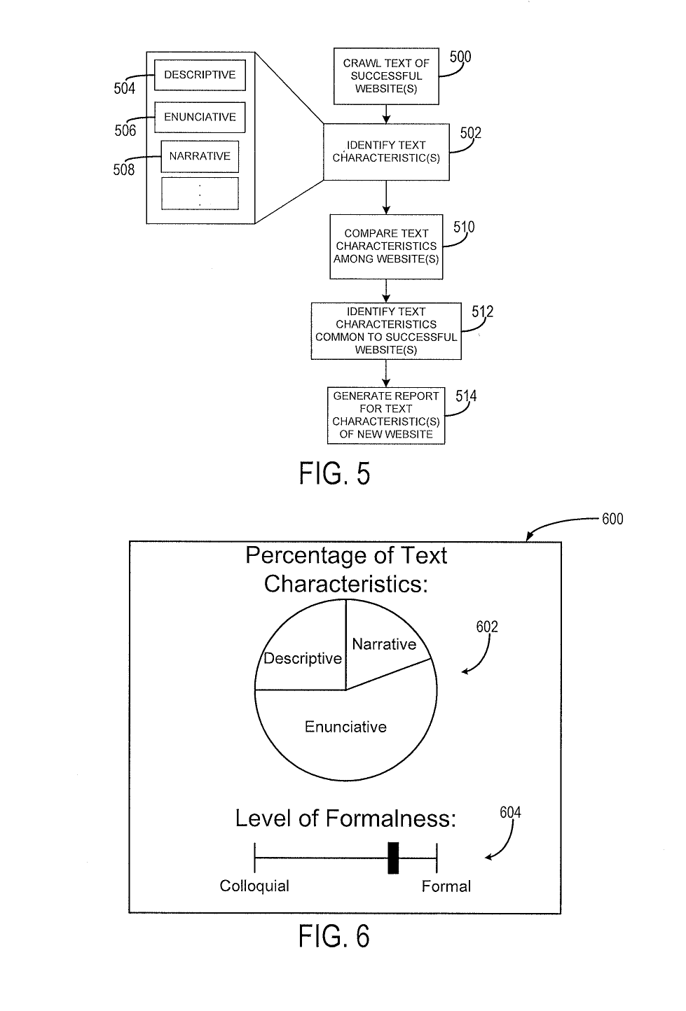

In one non-limiting example, as shown in the flowchart of FIG. 5, the keyword data 236 may be obtained from the various text sections 420, 422, and 424 of the existing website 408 of FIG. 4 using a semantic text analysis application 116 stored in the memory of and run on at least one server 102 of FIG. 1. The semantic text analysis application 116 may be a tracking application external to the website. In one example, the semantic text analysis application 116 is a tool designed to identify the text style and setting present within the text sections of existing websites. To begin the process, the semantic text analysis application 116 can crawl the text of the previously identified successful websites at process block 500. Next, at process block 502, the semantic text analysis application 116 may identify text characteristics of the crawled text. The text characteristics may include, but are not limited to, descriptive text, as shown at block 504, enunciative text, as shown at block 506, and/or narrative text, as shown at block 508.

Descriptive text 504 can be obtained from the existing websites hosted on the server 102 of FIG. 1, for example, and is accessible by the website content scanner 124. Descriptive text 504 may include, for example a description of the website's products and/or services. For example, descriptive text 504 may be identified in the introduction section 420 of the existing website 408 of FIG. 4. More specifically, the introduction section 420 provides details about what dental treatments are provided and an age range of patients that the practice provides its services to. Thus, the semantic text analysis application 116 may be configured to identify such descriptive text 504 that is commonly used in successful websites.

Similarly, enunciative text 506 can be obtained from the existing websites hosted on the server 102 of FIG. 1, for example, and is accessible by the website content scanner 124. Enunciative text 506 may include, for example a biography of the person(s) or group(s) providing the products and/or services offered by the website. For example, enunciative text 506 may be identified in the history section 424 of the existing website 408 of FIG. 4. More specifically, the history section 422 provides a short biography about the dentist who is providing services at the dental practice. As another non-limiting example, if the industry vertical identified was the music industry, the history section of the existing website may include a brief biography of the musician or band. Thus, the semantic text analysis application 116 may be configured to identify such enunciative text 506 that is commonly used in the successful websites.

Narrative text 508 can also be obtained from the existing websites hosted on the server 102 of FIG. 1, for example, and is accessible by the website content scanner 124. Narrative text 508 may include, for example, text related to a series or schedule of events or news associated with the website. For example, narrative text 508 may be identified in the contact section 422 and/or the social media section 426 of the existing website 408 of FIG. 4. More specifically, the contact section 422 may provide a link to a scheduling calendar to allow the user to set up an appointment. Additionally, or alternatively, the social media section 426 may provide links to news articles or press releases related to the dental practice. Thus, the semantic text analysis application 116 may be configured to identify such narrative text 508 that is commonly used in the successful websites.

In one non-limiting example, the semantic text analysis application 116 may be configured to identify a level of formalness of the various types of text 504, 506 and 508 included in the previously identified successful websites. For example, the semantic text analysis application 116 may be configured to access a database stored within the data center 120 (see FIG. 1) that identifies words and/or phrases as colloquial or formal, for example. Thus, as the semantic text analysis application 116 crawls the text of the website, the level of formalness, as related to the text, can be tracked. For example, a website for an upscale hotel or resort may provide text sections that include more formal language. Whereas a website for a young, musical band may provide text sections that include mostly colloquial text to engage a particular audience, for example.

In another example, the semantic text analysis application 116 may be configured to identify a volume of specific words and/or phrases within the content of the previously identified successful websites in the same industry vertical. This may be accomplished, for example, by utilizing a tokenizer stored on the server 102 that tracks the number of specific words and/or phrases common to the successful websites. The specific words and/or phrases that appear most frequently, for example, within the content of the successful websites may then be recommended to the new website being generated in the same industry vertical.

In yet another non-limiting example, the semantic text analysis application 116 may be configured to categorize text from content of the previously identified successful websites by assigning topic(s) and/or theme(s) to the content. This may be accomplished, for example, by using a N-gram model, which is a probabilistic language model, to identify unigrams, bigrams, and trigrams, for example, within the content of the successful websites in the same industry vertical. The semantic text analysis application 116 may also utilize Hidden Markov Models (HMM) to observe specific N-grams to determine hidden states (i.e., categories that can be assigned to the website content).

Once the text characteristics are identified at process block 502, the website content scanner 124 may compare the text characteristics among the related websites in the identified industry vertical. Then, at process block 512, the website content scanner 124 may identify the text characteristics that are common to the successful websites and generate a report 600 (see FIG. 6) for particular text characteristics recommended for the new website at process block 514. For example, as shown in FIG. 6, the report 600 may recommend that the new website include a certain percentage of descriptive text 504, enunciative text 506, and/or narrative text 508 based on the text characteristics common to the successful websites identified at process block 512. The percentage of various text characteristics may be identified by a graph, such as the pie graph 602 shown on the report 600. Additionally, or alternatively, the report 600 may include, for example a level of formalness of the text, as shown by the slider bar 604 of FIG. 6.

Returning to FIG. 2, appearance data 238 may also be obtained from the plurality of successful, existing websites as website related data at process block 230. Appearance data 238 may include, but is not limited to, color data, image data, web page patterns and layouts, templates, logos, and the like. As will be described in further detail below, the appearance data 238 obtained from the existing websites within the preferred industry vertical (e.g., dental) can be compared among one another to identify the ideal appearance data for the new website to be generated. Then, the newly generated website may include appearance features that are appealing to viewers and easy to navigate, for example, as previously determined from the appearance data 238 obtained from the plurality of existing websites.

Referring again to FIG. 4, the appearance data 238 obtained from the website 408 may include color data. For example, a first color 410 maybe identified by the website content scanner 124 for a website menu header 412 of the website 408, while a second color 414 may be identified for a background section 416 of the website. As will be described in further detail below, the website generation module 126, after scanning the content of the plurality of existing websites, can predict certain colors and color combinations that define successful websites within a particular industry vertical and apply those color combinations to the new website to be generated.

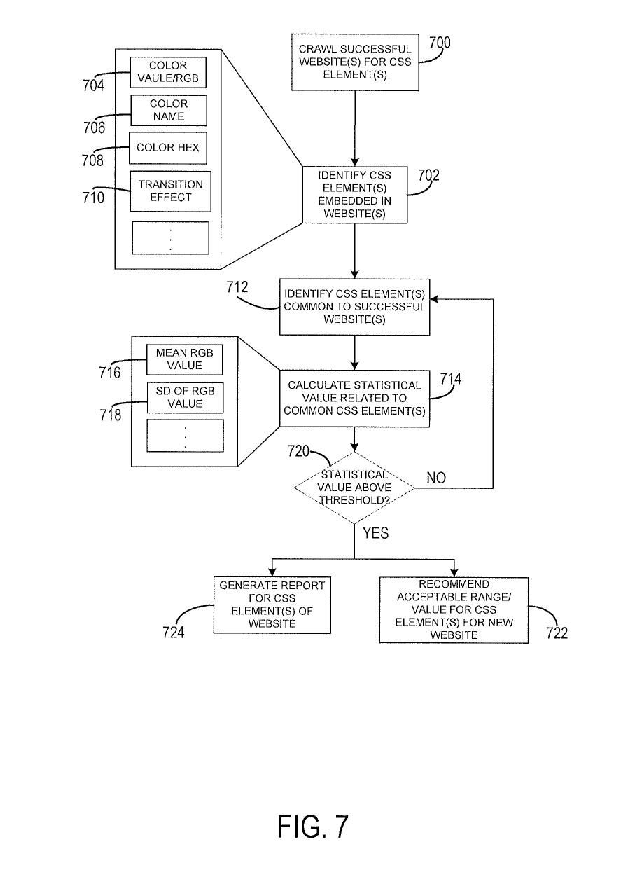

In one non-limiting example, as shown in the flowchart of FIG. 7, the color data may be obtained by scanning the content of the plurality of existing websites using the website content scanner 124 of FIG. 1. The website content scanner 124 may be configured to scan cascading style sheets (CSS) elements within CSS files included in or linked to by HTML code, for example, that describe the color and style values applied to the plurality of existing websites. The information provided in the existing websites' CSS elements can be used by the website content scanner 124 to track color data related to the plurality of existing websites. To begin the process, the website content scanner 124 can crawl the CSS elements of the successful websites at process block 700. Next, at process block 702, the website content scanner 124 may identify the CSS elements embedded within the successful websites' CSS files. The CSS elements may include, but are not limited to, color values, as shown at block 704, a color name 706, as shown at block 706, color hex values, shown at block 708, and/or transition effects, as shown at block 710 or other combination of style effects or settings.

Color values 704 may include, for example, RGB color values of the CSS elements of existing websites. An RGB color value may specified with: ‘rgb(red, green, blue)’ where each parameter (red, green, and blue) defines the intensity of the color and can be an integer between 0 and 255 or a percentage value from 0% to 100%. For example, the rgb(0,0,255) value is rendered as blue, because the blue parameter is set to its highest value (255) and the others are set to 0. Thus, the website content scanner 124 may be configured to scan all of the CSS color values 704 embedded within successful websites' web pages and identify color values 704 commonly used in the existing, successful websites.

Similarly, color names 706 may include, for example, standard color names of the CSS elements of existing websites. The 17 standard colors include: aqua, black, blue, fuchsia, gray, green, lime, maroon, navy, olive, orange, purple, red, silver, teal, white, and yellow. Each color name 706 may be associated with a color hex value 708. A hexadecimal color is specified with: #RRGGBB, where the RR (red), GG (green) and BB (blue) hexadecimal integers specify the components of the color. All values must be between 0 and FF. For example, the #0000ff value is rendered as blue, because the blue component is set to its highest value (ff) and the others are set to 0. Thus, the website content scanner 124 may be configured to scan all of the CSS color names 706 and color hex values 708 embedded within the successful websites' web pages and identify color names 706 and color hex values 708 commonly used in the successful websites.

Another CSS element that may be identified in the existing websites at process block 702 includes, transition effects 710, for example. Transition effects 710 are effects that let a CSS element gradually change from one style to another. The transition effect CSS element should include the CSS property to add an effect to and the duration of the effect. For example, the transition effect 710 may define edge sharpness of an object present on the existing website. Thus, the website content scanner 124 may be configured to scan all of the CSS transition effects 710 embedded within successful websites' web pages and transition effects 710 commonly used in the existing, successful websites.

Once the CSS elements are identified at process block 702, the website content scanner 124 can identify the CSS elements that are common to the successful websites. For example, the website content scanner 124 may determine that most of the successful websites in the dental industry use color values 704, color names 706 and/or color hex values 708 that are rendered as blue, and recommend the color blue to be incorporated into the new dental website. In one non-limiting example, the website content scanner 124 may be configured to calculate a statistical value related to the common CSS elements identified for the successful websites at process block 714.

The statistical value may include, but is not limited to, a mean RGB value, as shown at block 716, and/or a standard deviation of the RGB value, as shown at block 718. Thus, if one of the successful websites includes a CSS color value 704 of rgb(0,0,255), another one of the successful websites includes a CSS color value 704 of rgb(0,0,250), and a third successful website includes a CSS color value 704 of rgb(0,0,230), the website content scanner 124 may be configured to calculate a mean RGB value 716 (e.g., rgb(0,0,245)) and/or a range of RGB values 716 (e.g., rgb(0,0,230) to rgb(0,0,255)) to recommend for the new website at process block 722.

In one non-limiting example, the website content scanner 124 may automatically apply the calculated RGB value 716 to the new website. Additionally, or alternatively, the website content scanner 124 may be configured to generate a report, as shown at process block 724 that provides recommendations of CSS elements and values to apply to existing websites. The report generated at process block 724 may identify the existing CSS elements embedded within the existing website's web pages and identify whether the existing CSS elements include values similar to those of the successful websites within the same industry vertical.

In the case of calculating a standard deviation of the RGB values 718 at process block 714, the website content scanner 124 may optionally be configured to decide whether the standard deviation of the RGB values 718 is above a predetermined threshold at decision block 720. If the standard deviation of the RGB values 718 obtained from the successful websites is above the predetermined threshold at decision block 720, then the website content scanner 124 can recommend an RGB value, for example, for the new website at process block 722 and/or automatically apply the calculated RGB value 716 to the new website. Additionally, or alternatively, the website content scanner 124 may be configured to generate the comparative report at process block 724, as previously described.

Additionally, or alternatively, once the website content scanner 124 identifies the CSS color values 704, color names 706 and/or color hex values 708 of the successful websites, these elements 704, 706, 708 can be mapped against a color theme application having predetermined color themes stored thereon. If the values for the elements 704, 706, 708, for example, do not match one of the predetermined color themes, the color theme application may be configured to adjust and/or replace one or more of the elements 704, 706, 708 until an appropriate color theme is achieved based on an analogous color calculations.

Therefore, the website content scanner 124, based on the calculated statistical values and CSS elements, can recommend color data for existing or new websites. For example, the website content scanner 124 can indicate whether a light, clean look is representative of successful websites within the industry vertical, or a bold, dark look is representative of successful websites within the same industry vertical. In one example, if the website content scanner 124 determines that most of the successful, existing dental websites use CSS elements where the value is rendered as blue, then the color blue may be applied and/or recommended to the new or existing website.

Returning to FIG. 2, the appearance data 238 obtained from the plurality of existing websites can further include image data. For example, as shown in FIG. 4, the existing website 408 includes images 418 that are displayed in various sections of the website 408. The particular images 418 depicted on the website 408 are images of people smiling and, therefore, are relevant to the website 408 that belongs to the dental industry. Thus, the website generation module 126, after scanning the content of the plurality of existing websites, can predict types of images that are commonly depicted in successful websites within a particular industry vertical and apply those images to the new website to be generated. For example, for each of the images appearing in the successful, existing websites 408, the contents of any available “alt=” tags may be collected. Generally the alt tags will include key words or phrases that describe the images being depicted in the website 408. These keywords could then be used to identify suitable images and/or other content to incorporate into the new website being constructed, as described below.

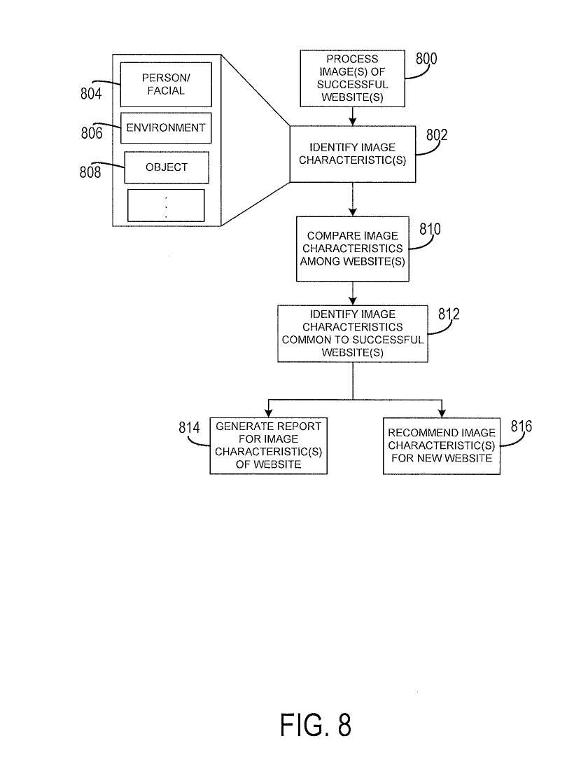

In one non-limiting example, as shown in the flowchart of FIG. 8, the appearance data 238 (i.e., image data) may be obtained from the images embedded within the web pages of the existing website 408 of FIG. 4 using an image processor application 116 stored in the memory of and run on at least one server 102 of FIG. 1. The image processor application 116 may be a tracking application external to the website. In one example, the image processor application 116 is a tool designed to recognize the presence or absence of certain objects within the images of existing websites. To begin the process, the image processor application 116 can crawl and process the images of the previously identified successful websites at process block 800. Next, at process block 802, the image processor application 116 may identify image characteristics of the processed images. The image characteristics may include, but are not limited to, person and/or facial characteristics, as shown at block 804, environmental characteristics, as shown at block 806, and/or object characteristics, as shown at block 808.

Person and/or facial characteristics 804 can be obtained from the existing websites hosted on the server 102 of FIG. 1, for example, and are accessible by the website content scanner 124. The website content scanner 124 may be in communication with the image processor application 116 that is configured to run a facial and/or person recognition software. The recognition software may instruct the image processor application 116 to run an algorithm to identify facial features by extracting landmarks, or features, for example, from the images on the existing website. For example, the algorithm may determine whether a person is present or absent in the image by identifying if certain facial features, such as the eyes, nose, cheekbones, and jaw, are present. Thus, if these features are present, the image processor application 116 can confirm that the image includes one or more persons. Additionally, these features may then be used to search for images from a database of available images, such as the data storage 114 of FIG. 1, with matching features. Thus, the image processor application 116 may be configured to identify such people and/or facial characteristics 804 (e.g., images of people smiling in the dental industry) that are commonly used in successful websites within the same industry vertical.

Similarly, environmental characteristics 806 and/or object characteristics 808 can be obtained from the existing websites hosted on the server 102 of FIG. 1, for example, and are accessible by the website content scanner 124. The website content scanner 124 may be in communication with the image processor application 116 that is configured to run an environmental and/or object recognition software. The recognition software may instruct the image processor application 116 to run an algorithm to identify environmental features and object features by extracting landmarks, or features, for example, from the images on the existing website. For example, the algorithm may determine whether the image represents an environment that is indoors or outdoors, for example, or whether the images includes objects related to the industry vertical (e.g., dental equipment if the industry vertical is dentistry). Thus, if certain environmental or object features are present, the image processor application 116 can confirm whether the image represents an indoor or outdoor environment what objects are present.

Such image characteristics 804, 806, 808 may be useful to identify, particularly when a new or existing website is being generated or modified within a particular geographical region. For example, it may be common for dental websites in the United States to include images of children smiling. In contrast, it may be common for dental website in China to include images of the dental practice's lobby, for example. Thus, a dental website being generated and/or modified in the United States may want to include images of children smiling, which is common among existing, successful websites in the dental industry, rather than an image of the dental office.

Once the image characteristics are identified at process block 802, the website content scanner 124 may compare the image characteristics among the successful websites in the identified industry vertical at process block 810. Then, at process block 812, the website content scanner 124 may identify the image characteristics that are common to the successful websites, compare the image characteristics to the current website's image characteristics in the case where the website already exists, and generate a report for particular image characteristics to be included in the existing website at process block 814. Additionally, or alternatively, the website content scanner 124 may recommend image characteristics for the new or existing website at process block 816. In one non-limiting example, the website content scanner 124 may automatically apply images to the new website, replace images on an existing website, and/or recommend a web page template having image characteristics common to the successful websites identified at process block 812.

Returning again to FIG. 2, the appearance data 238 obtained from the plurality of existing websites can also include pattern and template data. For example, as shown in FIG. 4, the existing website 408 includes the introduction section 420 that generally describes ABC Cosmetic Dentistry as a business. The existing website 408 further includes the contact section 422 that displays the business's phone number, email, and physical address. In addition the existing website 408 includes the history section 424 that briefly describes the dentists within ABC Cosmetic Dentistry's practice, and the social media section 426 that includes links to social media, customer feedback, blogs, and the like. The specific layout of the various sections 420, 422, 424, 426 may match a pre-built template provided by the website builder application 116 and, in combination with the other website related data, correspond to a particular industry vertical, for example. The website content scanner 124 may be configured to scan each of the plurality of existing websites and identify whether the specific pattern and/or layout of the website's pages match the pre-built template for the particular industry vertical. Thus, the website generation module 126, after scanning the content of the plurality of existing websites, can predict webpage patterns, layouts, templates, and the like that are commonly utilized in successful websites within a particular industry vertical and apply those webpage patterns, layouts, templates, and the like to the new website to be generated.

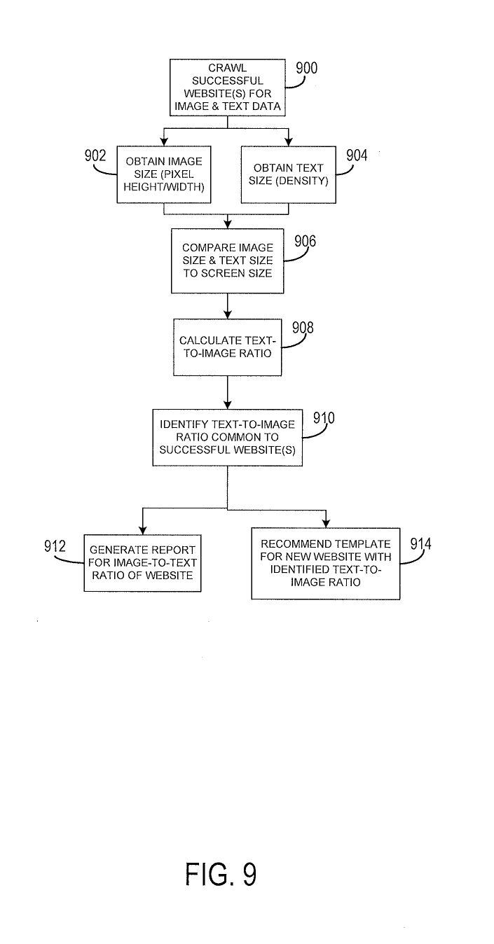

In one non-limiting example, as shown in the flowchart of FIG. 9, the appearance data 238 (i.e., pattern and template data) may be obtained from the images and text, for example, embedded within the web pages of the existing website 408 of FIG. 4 using the website content scanner 124 stored in the memory of—and run on—at least one server 102 of FIG. 1. The website content scanner 124 may include a tracking application external to the website. In one example, the website content scanner 124 may include a tool designed to identify an image-to-text ratio of the successful websites, for example. To begin the process, the website content scanner 124 can crawl the image and text data of the previously identified successful websites at process block 900. Next, at process block 902, the website content scanner 124 may obtain image characteristics, such as the image size, as defined by the image's pixel height and width.

In one non-limiting example, the website content scanner 124 may be configured to identify one or more HTML image tags (i.e., <img height> tag and <img width>), which add image height and width pixel data to web pages, contained within the identified successful websites. Thus, the website content scanner 124 may be configured to scan all of the image height and width tags and corresponding pixel values embedded within the successful websites' web pages and identify common image sizes contained in the image tags among the successful websites. The website generation module 126 may then be configured to automatically select an image to be included in the new website from a database of available images, such as the data storage 114 of FIG. 1. The selected image to be incorporated into the new website may have similar image tags and attributes that were identified among the successful websites.

Simultaneously, at process block 904, the website content scanner 124 may obtain text data, such as the text size in pixels. In one non-limiting example, the website content scanner 124 may be configured to identify one or more HTML tags or CSS settings that set the text size contained within the successful websites. Thus, the website content scanner 124 may be configured to scan all of the text size tags and corresponding pixel values embedded within the successful websites' web pages and identify common text sizes among the successful websites.

Next, at process block 906, the website content scanner 124 may be configured to compare the image size and text size, obtained at process block 902 and 902, to the screen size (in pixels) that the website is displayed on. For example, if the screen size is 1400×800 pixels, a text-to-image ratio can be automatically calculated at process block 908. Such a text-to-image ratio may be useful, particularly when a new or existing website is being generated or modified within a particular geographical region. For example, it may be common for dental websites in the United States to include large images. In contrast, it may be common for dental website in China to include mainly text on the web pages, for example. Thus, a dental website being generated and/or modified in the United States may want to include large images and less text, which is common among successful websites in the dental industry, rather than a webpage densely populated with text.

Once the text-to-image ratio is calculated at process block 908, the website content scanner 124 may be configured to identify text-to-image ratios common to successful websites at process block 910. In the case of generating a new website, for example, a template having a text-to-image ratio common to successful websites may be recommended or automatically applied to the new website at process block 914. Additionally, or alternatively, at process block 912, a report may be generated after the image-to-text ratio of an existing website has been identified and compared to the image-to-text ratio of successful, existing websites. The report generated at process block 912 may show a comparison, for example, of the existing website's text-to-image ratio and the text-to-image ratio of successful websites within the same industry vertical. Additionally, or alternatively, a new template, having the text-to-image ratio identified at process block 910, may be recommended to the existing website or the new template may automatically be applied to the existing website.

Returning again to FIG. 2, the appearance data 238 obtained from the plurality existing websites can also include business logo data. For example, as shown in FIG. 4, the existing website 408 includes a logo 428 near the website menu header 412. The specific style, size, and location, for example, of the logo 428 may be tracked by the website content scanner 124. The website content scanner 124 may then be configured to scan each of the plurality of existing websites and identify common logo styles, sizes, and locations, for example, of successful existing websites within the preferred industry vertical and apply those logo related features to the new website to be generated.

Returning to FIG. 2, the website content scanner 124 may further obtain website related data at process block 230 that includes business related data, as shown at block 240. Business related data 240 may include, but is not limited to appointment scheduling, products and/or equipment, articles on latest techniques related to the industry, business biography, blogs, sound and/or video data, and the like. As will be described in further detail below, the business related data 240 obtained from the existing websites within the preferred industry vertical (e.g., dental) can be compared among one another to identify common business related data of successful, existing websites that can then be displayed on the newly generated website.

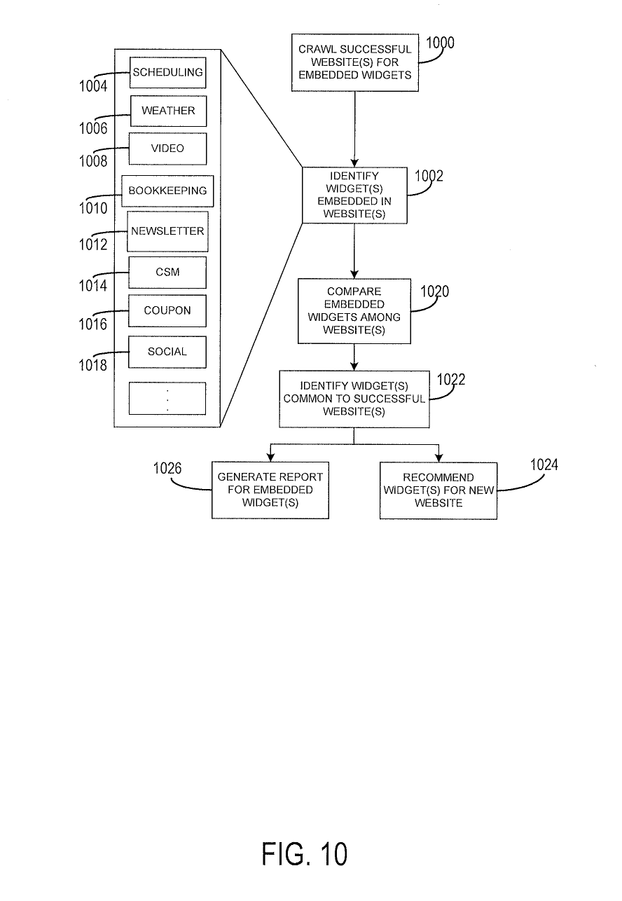

In one non-limiting example, as shown in the flowchart of FIG. 10, the business related data 240 may be obtained from the HTML code, for example, embedded within the web pages of the existing website 408 of FIG. 4 using the website content scanner 124 stored in the memory of—and run on—at least one server 102 of FIG. 1. In one example, the website content scanner 124 may include a tool designed to identify certain widgets embedded within successful websites, for example. To begin the process, the website content scanner 124 can crawl the HTML (or other code) of the previously identified successful websites at process block 1000. Next, at process block 1002, the website content scanner 124 may identify widgets embedded within the HTML of the successful websites within the same industry vertical.

In one non-limiting example, the website content scanner 124 may be configured to identify one or more signatures of particular widgets within the successful websites. Any sort of content, such as a URL, a specific line of code, or specific HTML tags (e.g., particular content contain within <details> tags) could operate to uniquely identify a widget within a particular website. For example, each installation of a particular widget may include a particular URL (e.g., the code for a weather widget may always include the URL www.weather.com/widget/display.php). Thus, the website content scanner 124 may be configured to scan all of the web pages of the successful websites to identify widget signatures. Once identified, the signatures can be tallied up to identify common widgets among the successful websites. The widgets may include, but are not limited to, scheduling widgets 1004, weather widgets 1006, video widgets 1008, bookkeeping widgets 1010, newsletter widgets 1012, CSM widgets 1014, coupon widgets 1016, social widgets 1018, and the like.

Once the widgets embedded within the successful websites are identified (e.g., by detecting the signatures of those widgets) at process block 1002, the website content scanner may be configured to compare the embedded widgets among the successful websites at process block 1020 and identify widgets that are common to the successful websites at process block 1022. Then at process block 1024, widgets common to successful websites may be recommended at process block 1024. For example, the website content scanner 124 may determine that scheduling widgets 1004 are common to successful websites in the dental industry. Thus, a scheduling widget 1004 may be recommended and/or automatically incorporated into a new or existing website to help generate web traffic at process block 1024.

Additionally, or alternatively, a report may be generated at process block 1026 for an existing website. The embedded widgets of the existing website may be compared to the embedded widgets of successful websites within the same industry vertical, for example. A comparison of the embedded widgets may be included in the report generated at process block 1026 to identify whether the existing website should update or add additional widgets to help generate more website traffic.

Such embedded widgets may be useful to identify, particularly when a new or existing website is being generated or modified. For example, the widgets that are common to successful websites may be generating high volumes of web traffic to the websites. Thus, new websites, or existing websites being updated, can implement the popular widgets to help drive traffic to the website. Knowing which widgets are driving website traffic may also help indicate, for example, which widgets are out of date and not popular anymore. For example, in some regions, guest book widgets are not frequently embedded in successful websites anymore. Instead, successful websites are including social commenting widgets.

Returning to FIG. 2, once all the website related data, as just described, is obtained by the website content scanner 124 at process block 230, the website generation module 126, hosted on the server 102, may be configured to identify attributes common to the plurality of successful, existing websites at process block 242. In one example, the website generation module 126 may identify common attributes (i.e., variables in the success algorithm), such as page position of the successful websites. Thus, if the page position corresponds to a high enough coefficient, meaning the attribute is likely to impact the success of the website, then that specific attribute is statistically significant. In addition, depending on the particular industry vertical and geographic location, the threshold for the success score may adjusted.

In one non-limiting example, the website content scanner 124 may be configured to identify common attributes among the top ten, twenty, or thirty existing websites determined to be successful. As previously described, the plurality of existing websites 108 may have been created using templates (not shown) corresponding to specific industry verticals provided by the website builder application 116. Thus, the website generation module 126 may determine a common template, for example, utilized by the existing websites within the preferred industry vertical (e.g., dental). For example, the common template for websites in the dental industry may have a format similar to that of the website 408, shown in FIG. 4, including the various sections 420, 422, 424, 426.

Another common attribute among the plurality of existing websites belonging to the preferred industry vertical may include, but is not limited to, all or a portion of the meta tag data 232, the SEO data 234, keyword data 236, appearance data 238 and business related data 240. For example, a common attribute among the successful, existing websites in the dental industry may include images of people smiling to portray straight, white teeth, as is shown in the images 418 on the website 408 of FIG. 4. Another common attribute among the plurality of existing websites may include a specific color combination displayed on the website, such as the first color 410 and second color 414 combination displayed on the website of FIG. 408. The common attributes among the plurality of existing websites identified by the website generation module 126 may also include any combination of the various website related data obtained at process block 230.

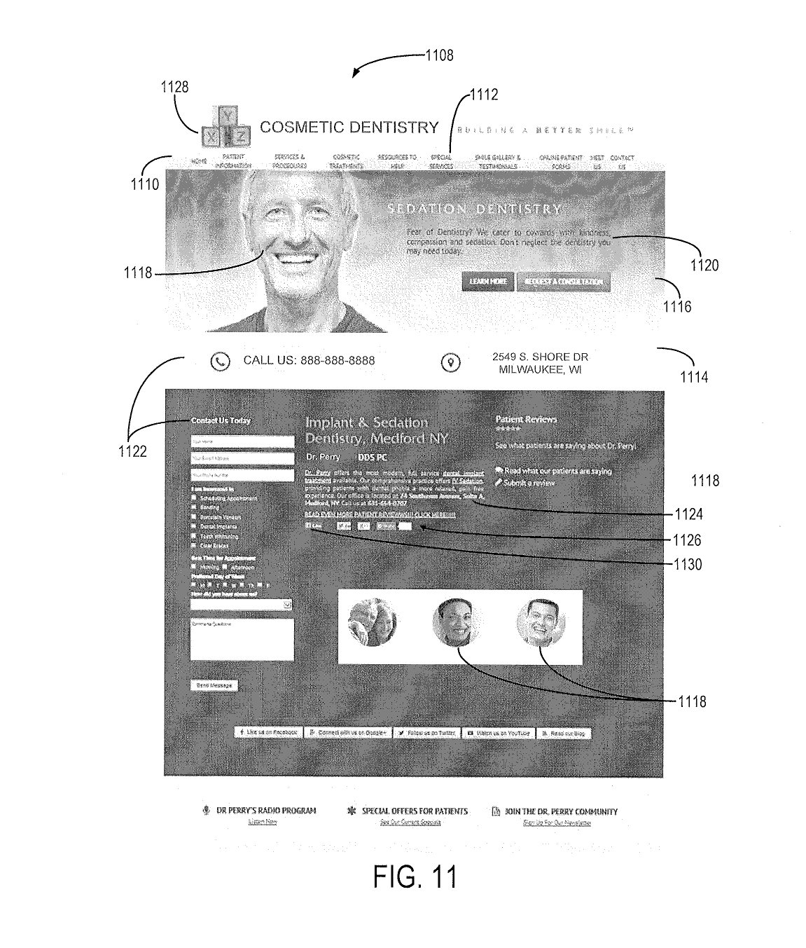

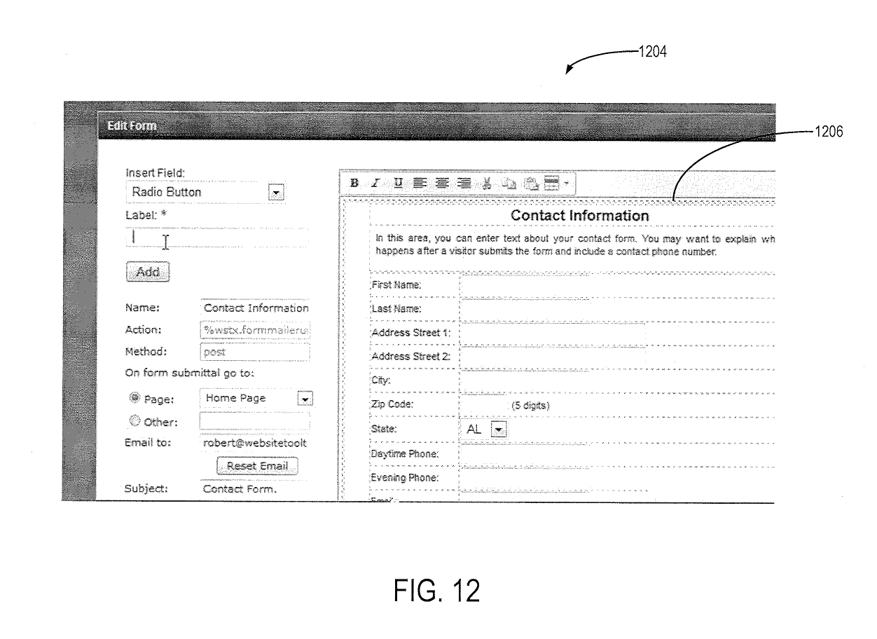

Once the attributes common to the successful websites are identified at process block 242, the new website may automatically be generated by the website generation module 126 at process block 244. The new website may include the attributes common to the existing websites 408 that were determined to be successful at decision block 228. An exemplary new website 1108 is shown in FIG. 11 that includes attributes determined to be successful by the website generation module 126. For example, the website generation module 126 may have determined that the website attributes of the existing website 408 shown in FIG. 4 were common among many of the other existing websites within the industry vertical, and thus, the website 1108 is substantially similar to the website 408.

For example, the first color 1110 and the second color 1114 combination utilized for the website menu header 1112 and the background section 1116, respectively, of the website 1108 are similar to the first color 410 and second color 414 combination used in the website 408. These colors may have been common to existing websites that were identified as being successful at decision block 228 of FIG. 2. Perhaps the first color 410/1110 and the second color 414/1114 combination is appealing and not distracting to visitors, thereby allowing visitors to focus on the important content of the website.

In addition, the new website 1108 includes images 1118 similar to the images 418 displayed on the website 408 of FIG. 4, which are images of people smiling and, therefore, are relevant to the websites in the dental industry. These types of images 418/1118 may have been common to existing websites that were identified as being successful at decision block 228, and thus also appear in the new website 1108.

In one non-limiting example, the website content scanner 124 may be configured to identify one or more HTML image tags (i.e., <img> tag), which add images and graphics to web pages, contained within the identified successful websites. The image tag may contain an alternative or ‘alt’ attribute, which is an attribute of the image tag that can include a text description of the image tag and/or the image itself or related keywords. Thus, the website content scanner 124 may be configured to scan all of the image tags and corresponding attributes (and, specifically, alt tags) embedded within the successful websites' web pages and identify common descriptions and keywords contained in the image tags among the successful websites. The website generation module 126 may then be configured to automatically select an image to be included in the new website 1108 from a database of available images, such as the data storage 114 of FIG. 1. The selected image to be incorporated into the new website 1108 may have similar image tags and attributes that were identified among the successful websites.

To verify the website generation module 126 automatically selects an image from the database that is appropriate for the new website 1108, the images stored in the database may be categorized by particular industries, such as the industries identified in the pull-down menu 302 on the user interface 304 in FIG. 3. For example, the website generation module 126 can identify an alternative attribute, common among the successful websites that includes the description “teeth” and “smile”, for example. The website generation module 126 can then select an image from the dental industry that includes these descriptions (e.g., “teeth” and “smile”), as opposed to randomly selecting an image from the database that includes the description “teeth” and “smile” resulting in an image, perhaps from an entertainment industry, of a clown smiling on the new website 1108, which may be inappropriate for a dental website.

Similarly, the new website 1108 generated by the website generation module 126 may include an introduction section 1120 that generally describes XYZ Cosmetic Dentistry as a business. The new website 1108 further includes a contact section 1122 that displays the business's phone number, email, and physical address. In addition the new website 1108 includes a history section 1124 that briefly describes the dentists within XYZ Cosmetic Dentistry's practice, and a social media section 1126 that includes links to social media, customer feedback, blogs, and the like. The specific layout of the various sections 1120, 1122, 1124, 1126 are substantially similar to the sections 420, 422, 424, 426 of the existing website 408, that were determined to be a common layout of successful existing websites in the dental industry, for example.

In addition, the new website 1108 includes a logo 1128 near the website menu header 1112. The specific style, size, and location of the logo 1128 is substantially similar to the style, size, and location of the logo 428 on the website 408 of FIG. 4. Thus, the website generation module 126 identified the specific style, size, and location of the logo 428 to be common among the other existing websites determined to be successful at decision block 228.

The new website 1108 may also include meta tags 232 similar to those of the identified successful websites, such as the existing website 408. For example, the keywords meta tag for the new website 1108 may include the words “teeth,” “dentist,” and “smile”, which were previously identified by the website content scanner 124 for the successful, existing website 408. The keywords meta tag including the words “teeth,” “dentist,” and “smile” may also have been identified as attributes common to the successful websites at process block 242. Similarly, the description meta tag for the new website 1108 may include “XYZ Cosmetic Dentistry is a family-oriented practice that uses the latest technology and techniques to maximize patient convenience, comfort and satisfaction”, which was previously identified by the website content scanner 124 for the successful, existing website 408. In addition, the description meta tags including similar business descriptions, as just described, may also have been identified as attributes common to the successful websites at process block 242.

The new website 1108 may further include SEO data 234 similar to those of the identified successful websites, such as the existing website 408. For example, the SEO data 234 for the new website 1108 may include keywords such as “fillings,” “repairs,” “root canal,” “crown,” “bridges,” and “implants”, which were previously identified by the website content scanner 124 as candidate keywords for the successful, existing website 408. The SEO data 234 including the keywords “fillings,” “repairs,” “root canal,” “crown,” “bridges,” and “implants” may also have been identified as attributes common to the successful websites at process block 242. Thus, the similar SEO data 234 incorporated into the new website 1108 may help target consumers that are searching for the procedures identified by the SEO data 234 and provided by the business.

In addition, the new website 1108 may include keyword data 236 similar to that of the identified successful websites, such as the existing website 408. For example, the keyword data 236 for the new website 1108 may include the keywords corresponding to the meta tag data 232 and/or the SEO data 234 of successful websites as previously described. Additionally, or alternatively, the keyword data 236 for the new website 1108 may include common keywords obtained from scanning the visible content of the successful, existing websites utilizing the website content scanner 124.

Lastly, the new website 1108 may include business related data 240 similar to those of the identified successful websites, such as the existing website 408. For example, the business related data 240 for the new website 1108 may include appointment scheduling, products and/or equipment, articles on latest techniques related to the industry, business biography, blogs, sound and/or video data, which were previously identified by the website content scanner 124 as business related data for the successful, existing website 408.

The new website 1108 may be displayed to the website administrator 112 on a user interface, such as the user interface 302 depicted in FIG. 3. At this point, the website administrator may enter website related data and/or preferences to customize the new website, as shown at process block 246 of FIG. 2. In some cases, the website administrator may use the website builder application 116 provided by the application server 118 of FIG. 1 to manipulate the content of the website. The data entered by the website administrator may include, but is not limited to, business data, as shown at block 248, appearance data, as shown at block 250, and business related data at shown at block 252.

Business data 248 may include the business name, business address, business phone number, contact data, and the like. An exemplary user interface 1204 displaying a business information screen 1206 is shown in FIG. 12 in which the website administrator may enter the business data 248 related to the new website 1108. The website administrator 112 may also review and edit any of the appearance data 250 and business related data 252 by manipulating the user interface 304 of the website builder application shown in FIG. 3. Thus, the present disclosure provides the website administrator with a new website template that includes attributes common to successful, existing websites within the industry vertical selected by the website administrator.

The invention claimed is:

1. A method, comprising:
receiving, by one or more servers communicatively coupled to a network, a request from at least one of a web browser and a computing device of a user for evaluation of a website, the request identifying an industry;
accessing, by the one or more servers, a remote data source to identify a plurality of existing websites belonging to the industry identified by the user, the remote data source storing industry identifiers for each of the plurality of existing websites;
determining, by the one or more servers, whether the plurality of existing websites are successful based on a success metric calculated using a weighted algorithm based on at least one of relevant metadata and a maximum potential market reach for the plurality of existing websites within the industry and a predetermined geographic location, the weighted algorithm requiring input data related to sources of website traffic weighted against the industry vertical and the predetermined geographic location and website ratings;
identifying, by the one or more servers, common attributes among the plurality of existing websites determined to be successful;
comparing, by the one or more servers, attributes of the website requested from the user to one or more of the common attributes of one or more of the plurality of existing websites determined to be successful once the success metric is normalized based on the maximum potential market reach; and
displaying, by the one or more servers, a report on a user interface including data related to the compared attributes.

2. The method of claim 1, further comprising the step of receiving, by the one or more servers, at least one of preference data and business data from the user at the user interface, the at least one of preference data and business data being used to customize the website.

3. The method of claim 1, wherein the one or more servers includes a web site content scanner configured to scan content of the plurality of existing websites determined to be successful to obtain website related data corresponding to the plurality of existing websites determined to be successful.

4. The method of claim 3, wherein the website related data obtained from scanning the content of the plurality of existing websites determined to be successful includes at least one of meta tag data, search engine optimization data, keyword data, appearance data, and business related data.

5. The method of claim 4, wherein the appearance data includes at least one of a color, an image, a pattern, a lay out, a cascading style sheet element, and a logo corresponding to each of the plurality of existing websites determined to be successful.

6. The method of claim 1, wherein the one or more servers includes an industry identification module having predetermined website patterns corresponding different industries stored thereon, the industry identification module configured to identify the plurality of existing websites belonging to the industry identified by the user based on the predetermined website patterns.

7. The method of claim 1, further comprising the steps of:
generating, by the one or more servers, a success value for each of the plurality of existing websites based on the success metric, the success metric including at least one of website traffic, website sales data, website ratings, and social media ratings corresponding to each of the plurality of existing websites; and
comparing the success value for each of the plurality of existing websites to a predetermined threshold value; and
when the success value is above the predetermined threshold value, generating a success value corresponding to the website requested from the user and generating the report including a comparison of the success values.

8. A method, comprising:
receiving, by one or more servers communicatively coupled to a network, a request from at least one of a web browser and a computing device of a user for evaluation of a website, the website belonging to an industry identified by the user;
identifying, by the one or more servers, common attributes among a plurality of existing websites within the industry identified by the user, the common attributes derived from a weighted algorithm based on at least one of relevant metadata and a maximum potential market reach for the plurality of existing websites within the industry and a predetermined geographic location;
comparing, by the one or more servers, attributes of the website requested from the user to one or more of the common attributes of one or more of the plurality of existing websites; and
displaying, by the one or more servers, a report on a user interface including data related to the compared attributes.

9. The method of claim 8, further comprising the step of receiving, by the one or more servers, at least one of preference data and business data from the user at the user interface, the at least one of preference data and business data being used to customize the website.

10. The method of claim 8, wherein the one or more servers includes a web site content scanner configured to scan content of the plurality of existing websites and identify the common attributes corresponding to the plurality of existing websites.

11. The method of claim 10, wherein the common attributes include website related data obtained from scanning the content of the plurality of existing websites, the website related data including at least one of meta tag data, search engine optimization data, keyword data, appearance data, and business related data.

12. The method of claim 8, further comprising the steps of:
generating, by the one or more servers, a success value for each of the plurality of existing websites based on a success metric, the success metric including at least one of website traffic, website sales data, website ratings, and social media ratings corresponding to each of the plurality of existing websites; and
comparing the success value for each of the plurality of existing websites to a predetermined threshold value; and
when the success value is above the predetermined threshold value, generating a success value corresponding to the website requested from the user and generating the report including a comparison of the success values.

13. The method of claim 8, wherein the one or more servers includes an industry identification module having predetermined website patterns corresponding different industries stored thereon, the industry identification module configured to identify the plurality of existing websites belonging to the industry identified by the user based on the predetermined website patterns.

14. A system, comprising:
one or more servers communicatively coupled to a network, the one or more servers including a processor configured to perform the steps of:
receiving, by the one or more servers, a request from at least one of a web browser and a computing device of a user for evaluation of a website, the website belonging to an industry identified by the user;
accessing, by the one or more servers, a remote data source to identify a plurality of existing websites belonging to the industry identified by the user, the remote data source storing industry identifiers for each of the plurality of existing websites;
determining, by the one or more servers, whether the plurality of existing websites are successful based on a success metric calculated using a weighted algorithm based on at least one of relevant metadata and a maximum potential market reach for the plurality of existing websites within the industry and a predetermined geographic location, the weighted algorithm requiring input data related to sources of website traffic weighted against the industry vertical and the predetermined geographic location and website ratings;
identifying, by the one or more servers, common attributes among the plurality of existing websites based on website related data obtained by the one or more servers once the success metric is normalized based on the maximum potential market reach;
comparing, by the one or more servers, attributes of the website requested from the user to one or more of the common attributes of one or more of the plurality of existing websites determined to be successful; and
displaying, by the one or more servers, a report on a user interface including data related to the compared attributes.

15. The system of claim 14, wherein the processor is configured to perform the step of receiving, by the one or more servers, at least one of preference data and business data from the user at the user interface, the at least one of preference data and business data being used to customize the website.

16. The system of claim 14, wherein the one or more servers includes a web site content scanner configured to scan content of the plurality of existing websites determined to be successful to obtain the website related data corresponding to the plurality of existing websites determined to be successful.

17. The system of claim 16, wherein the website related data obtained from scanning the content of the plurality of existing websites determined to be successful includes at least one of meta tag data, search engine optimization data, keyword data, appearance data, and business related data.

18. The system of claim 17, wherein the appearance data includes at least one of a color, an image, a pattern, a lay out, a cascading style sheet element, and a logo corresponding to each of the plurality of existing websites determined to be successful.

19. The system of claim 14, wherein the one or more servers includes an industry identification module having predetermined website patterns corresponding different industries stored thereon, the industry identification module configured to identify the plurality of existing websites belonging to the industry identified by the user based on the predetermined website patterns.

20. The system of claim 14, where in the processor is further configured to perform the steps of:
generating, by the one or more servers, a success value for each of the plurality of existing websites based on the success metric, the success metric including at least one of website traffic, website sales data, website ratings, and social media ratings corresponding to each of the plurality of existing websites; and
comparing the success value for each of the plurality of existing websites to a predetermined threshold value; and
when the success value is above the predetermined threshold value, generating a success value corresponding to the website requested from the user and generating the report including a comparison of the success values.
